(19) United States
(12) Patent Application Publication
(10) Pub. No.: US 2007/0070965 A1
(43) Pub. Date: Mar. 29, 2007

(54) Wireless terminal and wireless LAN system

(75) Inventor: Satoshi Abe, Kanagawa (JP)

Correspondence Address: YOUNG & THOMPSON, 745 SOUTH 23RD STREET, 2ND FLOOR, ARLINGTON, VA, 22202, US

(73) Assignee: NEC INFRONTIA CORPORATION, KANAGAWA (JP)

(21) Appl. No.: 11/528,665

(22) Filed: Sep. 28, 2006

(30) Foreign Application Priority Data
Sep. 29, 2005 (JP) 2005-284453

(51) Int. Cl. H04Q 7/24

(52) U.S. Cl. 370/338

(57) ABSTRACT

A wireless terminal includes a roaming detecting unit which detects roaming representing that a connected wireless LAN access point is changed and units which transmit a call control packet for authentication to the VoIP server by the detection of roaming by the roaming detecting unit. The roaming detecting unit compares identification information of a previously connected wireless LAN access point with identification information of a wireless LAN access point connected at the present every predetermined time, and detects roaming of the wireless LAN access point on the comparison result.

### BACKGROUND OF THE INVENTION

1. Field of the Invention

The present invention relates to a wireless terminal and a wireless LAN system and, more particularly, to a control technique in a roaming state of a wireless terminal.

2. Description of the Related Art

In a conventional wireless LAN system, a plurality of wireless LAN access points are present. The plurality of wireless LAN access points are connected to a switching hub. In the switching hub, ports corresponding to the plurality of wireless LAN access points, an address table which stores MAC addresses of wireless terminals wireless-connected in accordance with the ports corresponding to the access points, a control unit which perform connection control or the like of the wireless terminals with reference to the address table, and the like are arranged.

As a conventional wireless LAN system, for example, LAN systems described in JP-A 2003-116170, JP-A 2004-304570, and the like are known.

In a conventional technique, immediately after roaming of a wireless terminal, a switching hub transfers a packet from a VoIP server to a port to which a wireless LAN access point is connected before the roaming. For this reason, the wireless terminal cannot receive an incoming call, and time is required until the wireless terminal can receive an incoming call.

### SUMMARY OF THE INVENTION

It is an object of the present invention to provide a wireless terminal and a wireless LAN system which can receive an incoming call immediately after the wireless terminal performs roaming.

A wireless LAN system according to the present invention, in order to achieve the above object, in which a plurality of wireless LAN access points are connected to a switching hub, a wireless terminal is connected to the wireless LAN access points, and a VoIP server which performs call control of the wireless terminal, wherein the wireless terminal includes means which detects roaming representing that the connected wireless LAN access point is changed, and means which transmits a call control packet for authentication to the VoIP server for performing call control of an external VoIP by detection of the roaming by the detecting means.

The wireless terminal according to the present invention includes means which detects roaming representing the connected wireless LAN access point is changed, and means which transmits a call control packet for authentication to the VoIP server for performing call control of an external VoIP by the detection of roaming by the detecting means.

According to the present invention, when the wireless terminal detects roaming, the wireless terminal transmits a call control packet for authentication to the VoIP server to make it possible that the wireless terminal can receive an incoming call even immediately after the roaming.

### BRIEF DESCRIPTION OF THE DRAWINGS

FIG. 1 is a block diagram showing a configuration of an embodiment of a wireless LAN system according to the present invention;

FIG. 2 is a block diagram showing an internal configuration of a wireless terminal in FIG. 1; and

FIG. 3 is a block diagram showing an internal configuration of a switching hub in FIG. 1.

### DESCRIPTION OF THE PREFERRED EMBODIMENT

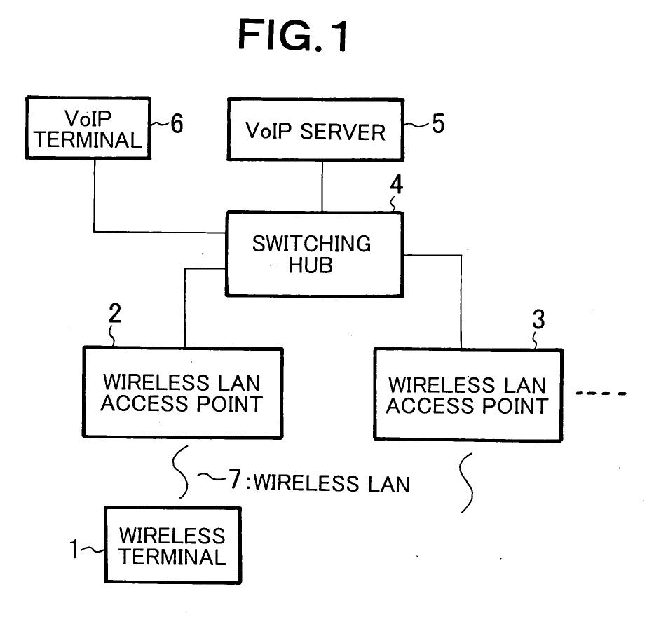

A best mode for carrying out the invention will be described below in detail with reference to the accompanying drawings. FIG. 1 is a block diagram showing a configuration of an embodiment of a wireless LAN system according to the present invention. In FIG. 1, to a switching hub 4, a wireless LAN access point 2, a wireless LAN access point 3, . . . , are connected.

A VoIP server 5 having a function that performs call control of VoIP is connected to the switching hub 4, and a wireless terminal 1 which is a client of the VoIP server 5 and which has a voice communication function performed by IP is wireless-connected to the wireless LAN access point 2 through a wireless LAN 7. Furthermore, a VoIP terminal 6 which is a client of the VoIP server 5 is connected to the switching hub 4.

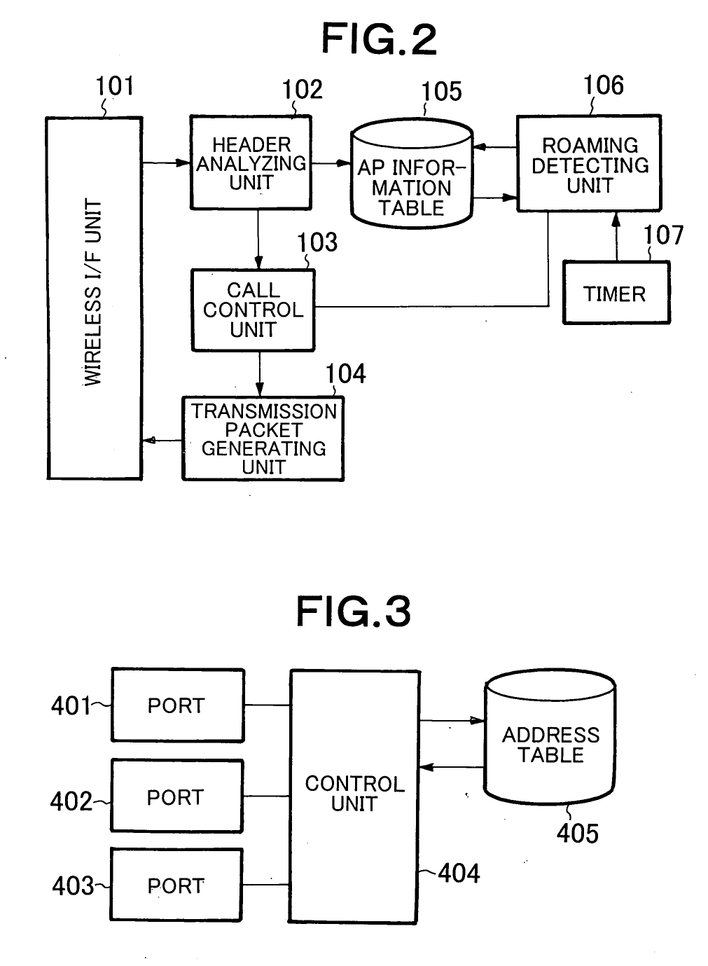

FIG. 2 is a block diagram showing an internal configuration of the wireless terminal 1. The wireless terminal 1 has a wireless I/F unit 101 which performs wireless transmission and reception. The wireless terminal 1 has header analyzing unit 102 which analyzes header information of a packet and detects information of a wireless LAN access point to which the wireless terminal 1 is connected. The header analyzing unit 102 writes the information of the wireless LAN access point in an AP information table 105.

The wireless terminal 1 has a call control unit 103 which call control of VoIP. In the embodiment, the call control unit 103 may have any call control protocol. The wireless terminal 1 has a transmission packet generating unit 104 which generates a packet to be transmitted.

Furthermore, the wireless terminal 1 has a roaming detecting unit 106 and a timer 107. The roaming detecting unit 106 loads information of a wireless LAN access point to which the wireless terminal 1 is connected at the present from the AP information table 105 at time intervals set in the timer 107 in advance and holds the information.

The roaming detecting unit 106 compares a MAC address of a wireless LAN access point newly loaded from the AP information table 105 at the time intervals of the timer 107 with a value held by the roaming detecting unit 106. When the wireless LAN access point is changed, the roaming detecting unit 106 notifies the call control unit 103 of roaming detection, and the call control unit 103 performs a re-authentication process on the basis of the roaming detection.

FIG. 3 is a block diagram showing an internal configuration of the switching hub 4. The switching hub 4 has a plurality of ports, the wireless LAN access point 2 is connected to a port 401, the wireless LAN access point 3 is connected to a port 402, and the VoIP server 5 is connected to a port 403. A plurality of other ports are connected to the switching hub 4 in association with the plurality of wireless LAN access points.

The switching hub 4 has a control unit 404 which controls the respective units and an address table 405 in which information representing correspondence between a MAC address of a connected terminal and the ports. When the switching hub 4 receives a packet, the port 403 refers to the address table 405 to check whether a destination MAC address of a received packet is registered. As a result of the check, when the destination MAC address is registered, the packet is transferred to the corresponding port. When the destination MAC address is not registered, the packet is transferred to all the ports.

Furthermore, when the switching hub 4 receives a packet, the switching hub 4 refers to a source MAC address of the packet to register corresponding information between the port which receives the packet and the MAC address of the port in the address table 405.

An operation of the embodiment will be described below. As shown in FIG. 1, when the wireless terminal 1 is connected to, for example, the wireless LAN access point 2, the header analyzing unit 102 of the wireless terminal 1 records the MAC address of the wireless LAN access point 2 on the AP information table 105.

The wireless terminal 1 transmits a call control packet of registration request to the VoIP server 5 through the wireless LAN access point 2 and the switching hub 4.

On the other hand, the roaming detecting unit 106 refers to the AP information table 105 every predetermined time of the timer 107 to compare the MAC address information of the wireless LAN access point with the MAC address information held in an internal recording area of the roaming detecting unit 106. For example, when the wireless terminal 1 is connected to the wireless LAN access point 2, a MAC address of the wireless LAN access point 2 is recorded on the AP information table 105. For this reason, the roaming detecting unit 106 holds the MAC address of the wireless LAN access point 2 each predetermined time.

In this case, when the wireless terminal 1 performs roaming to the wireless LAN access point 3, a MAC address of the wireless LAN access point 3 is recorded on the AP information table 105. However, the roaming detecting unit 106 holds the MAC address of the wireless LAN access point 2.

For this reason, the roaming detecting unit 106 detects that wireless LAN access points are changed on the basis of the comparison result of the MAC address information acquired from the AP information table 105 and the held MAC address information to determine that roaming is performed. When it is determined that the roaming is performed, the roaming detecting unit 106 urges the call control unit 103 to authenticate the VoIP server 5. As a result, the call control unit 103 controls the transmission packet generating unit 104 to generate a call control packet for authentication and transmits the call control packet for authentication to the VoIP server 5 again.

In this case, as a call control protocol used in VoIP, an SIP is known. In the SIP, a terminal issues a signal called REGISTAR to a server device, so that the server device registers a position of the terminal. In general, an EXPIRE TIME value is set in a terminal, and a REGISTAR signal is periodically issued to the server device at predetermined time intervals determined by the EXPIRE TIME value. The value is time falling within the range of 5 minutes to 60 minutes.

In the embodiment, when the wireless terminal detects roaming regardless of the EXPIRE TIME value determined in the wireless terminal, a re-authentication process such as the transmission of a REGISTAR signal described above is immediately performed.

In this case, when the wireless terminal 1 detects roaming, a call control packet for authentication is transmitted to the VoIP server 5. However, in the switching hub 4 through which the call control packet passes, the control unit 404 updates the address table 405. More specifically, since the wireless terminal 1 is connected to the wireless LAN access point 2 before roaming is detected, the port 401 and MAC address information the wireless terminal 1 are associated with every other on the address table 405 of the switching hub 4.

In this state, it is assumed that the wireless terminal 1 is connected to the wireless LAN access point 3, that roaming of the wireless terminal 1 is detected, and that a call control packet for authentication is transmitted from the wireless terminal 1 through the switching hub 4. In this case, the control unit 404 analyzes the packet to update the address table 405 such that the port 402 corresponding to the wireless LAN access point 3 after roaming is associated with the MAC address information of the wireless terminal 1.

Therefore, the packet transmitted from the VoIP server 5 to the wireless terminal 1 arrives at the wireless terminal 1 through the port 402 and the wireless LAN access point 3. For this reason, it can be prevented that an incoming call from the VoIP terminal 6 cannot be received. In a conventional technique, when a wireless terminal performs roaming, a switching hub transfers a packet from a VoIP server to the port 401 to which the wireless LAN access point 2 before roaming is connected, long time is required until the wireless terminal receives an incoming call.

1. A wireless LAN system in which a plurality of wireless LAN access points are connected to a switching hub, a wireless terminal is connected to the wireless LAN access points, and a VoIP server which performs call control of the wireless terminal, wherein the wireless terminal comprises means which detects roaming representing that the connected wireless LAN access point is changed, and means which transmits a call control packet for authentication to the VoIP server for performing call control of an external VoIP by detection of the roaming by the detecting means.

2. The wireless LAN system according to claim 1, wherein the detecting means compares identification information of a previously connected wireless LAN access point with identification information of a wireless LAN access point connected at the present every predetermined time, and detects roaming of the wireless LAN access point on the comparison result.

3. The wireless LAN system according to claim 1, wherein the packet transmitting means immediately transmits a call control packet for authentication regardless of an EXPIRE TIME value set in the wireless terminal in advance and related to communication with an external device when roaming of the wireless LAN access point is detected.

4. A wireless terminal comprises: means which detects roaming representing a connected wireless LAN access point is changed; and means which transmits a call control packet for authentication to a VoIP server which performs call control of an external VoIP by detection of roaming by the detecting means.

5. The wireless terminal according to claim 4, wherein the detecting means compares identification information of a previously connected wireless LAN access point with identification information of a wireless LAN access point connected at the present every predetermined time, and detects roaming of the wireless LAN access point on the comparison result.

6. The wireless terminal according to claim 4, wherein the packet transmitting means immediately transmits a call control packet for authentication regardless of an EXPIRE TIME value set in the wireless terminal in advance and related to communication with an external device when roaming of the wireless LAN access point is detected.

7. The wireless LAN system according to claim 2, wherein the packet transmitting means immediately transmits a call control packet for authentication regardless of an EXPIRE TIME value set in the wireless terminal in advance and related to communication with an external device when roaming of the wireless LAN access point is detected.

8. The wireless terminal according to claim 5, wherein the packet transmitting means immediately transmits a call control packet for authentication regardless of an EXPIRE TIME value set in the wireless terminal in advance and related to communication with an external device when roaming of the wireless LAN access point is detected.
